(19) United States
(12) Patent Application Publication
(10) Pub. No.: US 2016/0328810 A1
(43) Pub. Date: Nov. 10, 2016

(54) SYSTEMS AND METHODS FOR COMMUNICATIONS REGARDING A MANAGEMENT AND SCORING TOOL AND SEARCH PLATFORM

(71) Applicant: LuxurInvest LLC, Washington, DC (US)

(72) Inventors: Nicolas Chaillan, Washington, DC (US); Jorge Andres Brugo, Miami, FL (US)

(21) Appl. No.: 15/138,777

(22) Filed: Apr. 26, 2016

Related U.S. Application Data
(60) Provisional application No. 62/157,207, filed on May 5, 2015.

(51) Int. Cl. G06Q 50/16

(52) U.S. Cl. CPC G06Q 50/165

(57) ABSTRACT

A system and method for providing communications corresponding to a management and scoring tool and search platform. In one or more embodiments, the management and scoring tool and search platform allows remote devices to perform customized searching of previously scored units via communications using a user interface generated by the management and scoring tool. In one or more embodiments, the units can correspond to pre-construction real estate projects.

### CROSS-REFERENCE TO RELATED APPLICATIONS

This application claims the benefit of U.S. Provisional Application No. 62/157,207 filed on 5 May 2015, which is hereby incorporated by reference in its entirety.

### FIELD OF THE DISCLOSURE

The present disclosure relates generally to improved communications between a real estate investment platform and remote computing devices of investors, allowing investors to search for pre-construction real estate projects that have been previously scored and ranked.

### BACKGROUND

Real estate developers typically have to pre-sell a certain percentage of real estate developments to obtain construction funding from banks or other lending institutions. Investors, on the other hand, find investing in pre-construction real estate a highly risky but potentially rewarding venture. In most cases, agreements between developers and investors are signed years before a shovel even touches the ground. In conventional construction projects, investor rewards are derived from the opportunity to purchase a future housing unit/office space at today's price and be able to sell said purchased unit at a higher price in the future. Unfortunately, these transactions generally incur a large amount of the risk associated with the construction projects. The risk is derived from numerous possibilities, including: the developer not fulfilling all development expectations (e.g., the project never being completed, etc.); the investor being unable to sell his/her associated units at a profit upon completion of the project, or the possibility of the investor not being able to sell his/her associated units at all, among others.

Conventional methods for managing risk in real estate investment typically address existing real estate as opposed to addressing pre-construction real estate projects. Additionally, one of the top priorities of investors is improving ways to locate pre-construction real estate having the right balance of risk and potential profit.

Accordingly, it is desirable to develop improved systems, methods and techniques for locating and assessing pre-construction real estate projects to assist developers in meeting investors while providing the investor with ways to single out the best investment opportunities among all offers coming from real estate developers. Moreover, it is desirable to develop improved systems, methods and techniques for analyzing development projects and units and communicating information regarding the analysis.

### SUMMARY

A system and method for scoring real estate developers and managing real estate pre-construction investment is disclosed. In one or more embodiments, a real estate investment management tool allows investors to perform customized investment research on pre-construction real estate that have been previously scored and ranked, thereby allowing the investor to determine projects that closely match his/her investment criteria.

In one or more embodiments, the real estate management tool operates within a system architecture that includes components that dynamically interact with each other through network connections. In these embodiments, the system includes one or more components, such as, for example, client computing devices, user interfaces, a real estate management tool, communication networks, an internal database, and external data sources. The real estate management tool further includes software modules such as, for example, a data collection module, a developer scoring module, a project scoring module, a unit scoring module, a matching module, and a financial module, among others. It should be understood that the system can include more components, less components, or different components depending on desired goals.

In exemplary operation, an investor accesses a real estate management tool using a user interface through a communication network to register with the real estate management tool. The real estate management tool then generates the user interface and displays a questionnaire for gathering qualification data from the investor. The investor then inputs data to answer the questionnaire and submits the qualification data to the real estate management tool. The real estate management tool then stores said qualification data at an internal database. In one embodiment, the real estate management tool is constantly retrieving information from external data sources and registered developers in the system so as to feed the internal database with relevant information about past, present, and future projects of the developers. In this embodiment, the real estate management tool runs a plurality of algorithms, using different software modules, which use different types of criteria to score developers, projects, and units. In one or more embodiments, a developer scoring module within the real estate management tool assigns weights to a set of criteria such as, for example, timely delivery, performance record, financial strength, quality, and failure rate, and produces a developer score that ranges from 0% to 100%. In one or more embodiments, a project scoring module within the real estate management tool assigns weights to a set of criteria such as, for example, developer, location, delighters, price, and stage of development, and produces a project score that ranges from 0% to 100%. In one or more embodiments, a unit scoring module within the real estate management tool assigns weights to a set of criteria such as, for example, project, floor, view, price, and unit type, and produces a unit score that ranges from 0% to 100%. In one or more embodiments, the investor performs a search of units that includes a list of preferences. Examples of preferences includes unit specifics such as, for example, size of the unit in square feet, number of bedrooms, number of bathrooms, specific views, specific heights, and special units. In these embodiments, the real estate management tool processes the search query and applies a matching algorithm that uses investor's data, developer scores, project scores, and unit scores to match units to investor's qualification data and preferences. In one or more embodiments, the real estate management tool also provides the investor with features for assistance in financing, insurance services, furniture, law firms, and the like.

According to some embodiments, a method for assigning scores to developers, projects and units includes a plurality of steps performed by a processor. The steps include: collecting developer's portfolio data associated with a plurality of developers from external data sources; storing developer data in an internal database; and running a plurality of algorithms to score developers, projects, and units.

According to some embodiments, a method for performing investment research on pre-construction units in the real estate management tool includes a plurality of steps performed by a processor. The steps include: displaying a pre-loaded questionnaire to the investor for personalizing the investor's search; collecting the search criteria provided by the investor; applying a matching algorithm with investor qualification data and developers portfolio data; displaying an initial set of results; verifying if more filters to narrow down the search are needed; if more filters are needed, then applying a matching algorithm to new filters; if more filters are not needed, then managing investment transactions.

Numerous other aspects, features and benefits of the present disclosure may be made apparent from the following detailed description taken together with the drawing figures.

### BRIEF DESCRIPTION OF THE FIGURES

Non-limiting embodiments of the present invention are described by way of example with reference to the accompanying figures which are schematic and are not intended to be drawn to scale. Unless indicated as representing the background art, the figures represent aspects of the invention.

FIG. 1 is a block diagram illustrating a system for managing pre-construction real estate investments, according to an embodiment;

FIG. 2 is a block diagram illustrating an exemplary computing device in which one or more embodiments of the present disclosure may operate, according to an embodiment;

FIG. 3 is a block diagram illustrating an exemplary real estate management tool portion of the system of FIG. 1, according to an embodiment.

FIG. 4 is an exemplary embodiment of a set of developer criteria types, ranges, and associated weights for calculating a developer score for developers.

FIG. 5 is an exemplary embodiment of a set of developer criteria, ranges, and associated weights for calculating a developer score for developers.

FIG. 6 is an exemplary embodiment of a set of project criteria types, ranges, and associated weights for calculating a project score for projects.

FIG. 7 is an exemplary embodiment of a set of project criteria, ranges, and associated weights for calculating a project score for projects.

FIG. 8 is an exemplary embodiment of a set of unit criteria types, ranges, and associated weights for calculating a unit score for units.

FIG. 9 is an exemplary embodiment of a set of unit criteria, ranges, and associated weights for calculating a unit score for units.

FIG. 10 is flowchart of a method for assigning scores to developers, projects, and units, according to an embodiment.

FIG. 11 is an exemplary illustration of a user interface in the real estate management tool that allows investors to customize investment research on units, according to an embodiment;

FIG. 12 is an exemplary illustration of a user interface in the real estate management tool that allows investors to manage their investment research, according to an embodiment;

FIG. 13 is an exemplary illustration of a user interface in the real estate management tool that displays project profiles of interest, according to an embodiment;

FIG. 14 is flowchart of a method for performing investment research on pre-construction units in the real estate management tool, according to an embodiment.

### DETAILED DESCRIPTION

Reference will now be made to the exemplary embodiments illustrated in the drawings, and specific language will be used here to describe the same. It will nevertheless be understood that no limitation of the scope of the invention is thereby intended. Alterations and further modifications of the inventive features illustrated here, and additional applications of the principles of the inventions as illustrated here, which would occur to one skilled in the relevant art and having possession of this disclosure, are to be considered within the scope of the invention.

System Components and Architecture

Various embodiments consistent with the invention include systems, components, methods, and computer program products that provide a novel real-time analysis, scoring, and matching functionality and a new real-time communication channel that alerts investors to pre-construction real estate units that are available and that match provided criteria. The described embodiments may provide investors with an opportunity to be alerted of pre-construction real estate units that match his/her investment criteria. Similarly, by providing real-time communications to devices of the investors, the described embodiments may also provide the investors with real-time opportunities to obtain real estate investments (i.e., while the real estate remains available), and a degree of confidence or certainty that the investment will be successful.

Various embodiments described herein are directed to a novel pre-construction real estate investment analysis, scoring, matching, communication, and alert system that transmits to inventors, on their local computers, customized lists of developers, projects, and units with scores in real time from a remote system that interacts with external data sources. Current conventional systems, in contrast, do not have the technical ability to analyze pre-construction real estate data in real time or to communicate directly with investors in real time to provide real time analysis and scoring. This is a significant technical drawback of conventional systems because information about pre-construction real estate has the potential to be time sensitive. The investor's ability to identify pre-construction real estate investment opportunities in real time increases the likelihood of procuring the investment opportunity, and the analysis and scoring minimizes the investor's risk. Various embodiments described herein and consistent with the present invention solve these technical problems, among others.

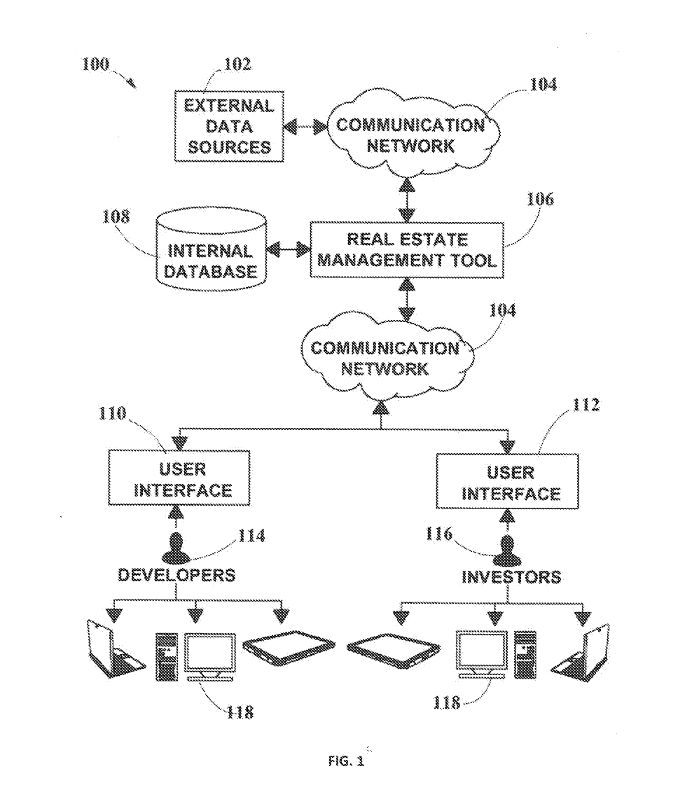

FIG. 1 is a block diagram illustrating a system 100 for managing real estate pre-construction investment. In one or more embodiments, the system for managing real estate investments allows investors to invest in thoroughly selected and scored pre-construction real estate so that the investor can choose an investment that is desirable to him or her. In other embodiments, the system also provides the investor with features for assistance in obtaining financing, insurance services, furniture, law firms, and the like.

According to an embodiment, system 100 includes external data sources 102, communication network 104, real estate management tool 106, internal database 108, user interface 110, user interface 112, developers 114, and investors 116. Developers 114 and investors 116 includes client computing devices 118 such as smartphones, desktop computers, laptop computers, servers, tablets, PDAs, and the like. It should be understood that system 100 can include more components, less components, or different components depending on desired goals.

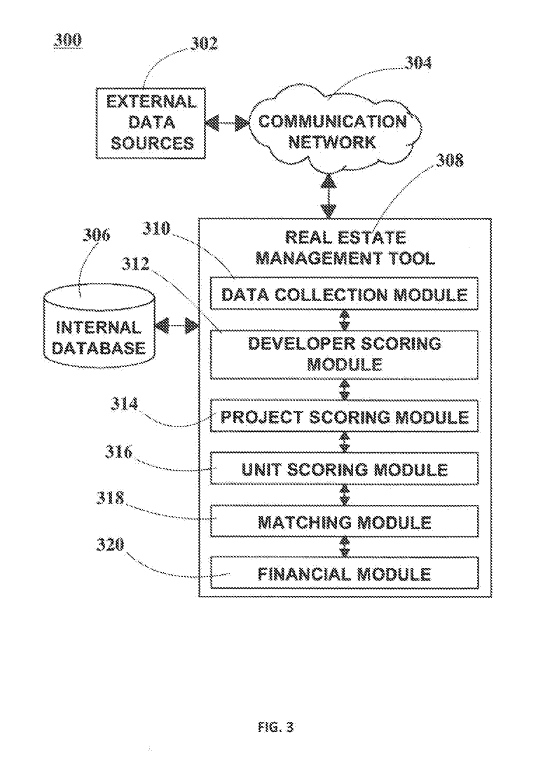

According to an embodiment, real estate management tool 106 further includes one or more software modules such as, for example, one or more data collection modules, one or more developer scoring modules, one or more project scoring modules, one or more unit scoring modules, one or more matching modules, and one or more financial modules. The software modules contained/operating within real estate management tool 106 are further described in FIG. 3.

In FIG. 1, real estate management tool 106 is operatively coupled to and in bi-directional communication with one or more external data sources 102, internal databases 108, user interface 110, and user interface 112. Developers 114 is/are further operatively coupled to and in bi-directional communication with user interface 110, which can represent one or more user interfaces, and one or more client computing devices 118. Investors 116 is/are further operatively coupled to and in bi-directional communication with user interface 112, which can represent one or more user interfaces, and one or more client computing devices 118.

Each of the different components of system 100 may be implemented in any type of suitable processor-controlled device that receives, processes, and/or transmits digital data, configured as further described below. Examples of devices incorporating one or more suitable processor-controlled devices include smartphones, desktop computers, laptop computers, servers, tablets, PDAs, specialized computing platforms or devices for data processing, scoring modules, matching algorithms, and the like. Each of the sub-components within real estate management tool 106 may be a set of computer instructions executed by central processing units that run computer executable program instructions or related algorithms. Each central processing unit may be a component of a computing device such as a server, a single computer, or multiple computers in a distributed configuration.

In FIG. 1, real estate management tool 106 is implemented as software that runs on a central server including a processing unit for running related algorithms or computer executable program instructions. Processing unit may include a processor with computer-readable medium, such as a random access memory (RAM) (not shown) coupled to the processor. Examples of a processor may include a microprocessor, application specific integrated circuit (ASIC), and field programmable object array (FPOA), among others. In some embodiments, real estate management tool 106 receives investor qualification data from investors 116 using user interface 112 through communication network 104 and stores said investor qualification data at internal database 108. In these embodiments, the investor qualification data may include location, neighborhood, type of location premium, investment size, carrying cost budget, type of risk, developer score requirement, number of units to purchase, location of unit within the building, and type of mix. Further to these embodiments, the qualification data also includes details on the project such as, for example, design/style of the project, type of ownership, branded project, project size, type of finishes, and type of amenities. In these embodiments, the qualification data also includes unit specifics such as, for example, size of the unit in square feet, number of bedrooms, number of bathrooms, specific views, specific heights, and special units. Further to these embodiments, the qualification data also provides referral questions that include whether the investor requires financing, range of financing as a percentage, assistance with financing, assistance with finishes, assistance with insurance services, assistance with furniture, assistance with a law firm, and the like. In some embodiments, real estate management tool 106 receives portfolio data from developers 114 and external data sources 102, and stores said data in internal database 108. In these embodiments, portfolio data from developers 114 may include information related to the developer's performance and financial status, projects, and units, further described in FIG. 3. Further to these embodiments, real estate management tool 106 also receives historical data from developers and from external data sources 102. In these embodiments, real estate management tool 106 retrieves portfolio data of developers from internal database 108 and external data sources 102 to score the developer portfolio data from developers and stores said developer portfolio data back in internal database 108. Further to these embodiments, real estate management tool 106 allows the investors to manage their investments and provide other features for assisting the investor in financial transactions, which are further described in FIG. 3.

In one or more embodiments, internal database 108 and external data sources 102 are implemented as relational databases that provide functions of fetching, indexing, and storing data. Internal database 108 and external data sources 102 may be implemented through database management systems (DBMS), such as, MySQL, PostgreSQL, SQLite, Microsoft SQL Server, Microsoft Access, Oracle, SAP, dBASE, FoxPro, IBM DB2, LibreOffice Base, FileMaker Pro, and/or any other type of database that may organize collections of data.

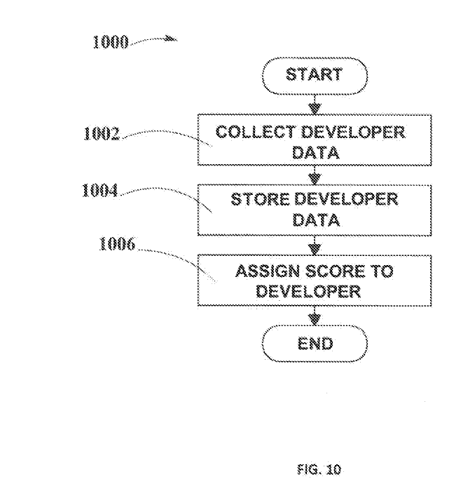

In exemplary operation, investor 116 accesses real estate management tool 106 using user interface 112 through communication network 104 to register with real estate management tool 106. In additional or alternative embodiments, prior to investor 116 accessing real estate management tool 106 using user interface 112, real estate management tool 106 generates user interface 112 in response to requests to access real estate management tool 106 from remote computing devices, such as, for example, client computing devices 118. Based on the requests, real estate management tool 106 can store, in memory (e.g., internal database 108), destination addresses of client computing device 118. In various embodiments, upon generation of user interface 112, and based on instructions stored in memory, real estate management tool 106 can communicate with client computing devices 118 via a transmitter (e.g., a transmitter of real estate management tool 106). Such communication can cause client computing devices 118 to auto-launch a user interface application corresponding to user interface 112. In some implementations, the user interface application may display information corresponding to embodiments described below (e.g., as shown in FIGS. 10-12, described below). In further implementations, the user interface application may cause client computing devices 118 to enable connection to real estate management tool 106 to access more information. In some embodiments, the user interface application may automatically connect to an information source such as real estate management tool 106 and/or internal database 108. The information source connected to may provide, for example, developer scores, project scores, unit scores, and matched units. Additionally, the information source connected to may automatically redirect inventors to financial entities. Thus, using the information provided by this new, real-time communication link and user interface between real estate management tool 106 and client computing devices 118, the client computing devices 118 can act immediately to obtain investment units (i.e., while the units remain available).

User interface 112 can display data such as a questionnaire, provided by real estate management tool 106, for gathering investor qualification data from investor 116. Investor 116 can input data to answer the questionnaire and submit qualification data to real estate management tool 106 via user interface 112. Real estate management tool 106 then stores said investor qualification data at internal database 108. In one embodiment, real estate management tool 106 is frequently retrieving information from external data sources 102 and developers 114 so as to feed the internal database with relevant information about the developers. In this embodiment, real estate management tool 106 runs a plurality of algorithms that use different types of criteria to score the developers including all of their projects and units. In one or more embodiments, a developer scoring module within real estate management tool 106 assigns weights to a set of criteria such as, for example, timely delivery, performance record, financial strength, quality, and failure rate, and produces a developer score that ranges from 0% to 100%. In one or more embodiments, a project scoring module within real estate management tool 106 assigns weights to a set of criteria such as, for example, developer, location, delighters, price, and stage of development, and produces a project score that ranges from 0% to 100%. In one or more embodiments, a unit scoring module within real estate management tool 106 assigns weights to a set of criteria such as, for example, project, floor, view, price, and unit type, and produces a unit score that ranges from 0% to 100%. In one or more embodiments, investors 116 perform a search of units that includes a list of preferences. Examples of preferences includes unit specifics such as, for example, size of the unit in square feet, number of bedrooms, number of bathrooms, specific views, specific heights, and special units. In these embodiments, real estate management tool 106 processes the search query and applies a matching algorithm that uses investors' data, developer scores, project scores, and unit scores to match units to investors' qualification data and preferences. In one or more embodiments, real estate management tool 106 also provides investors 116 with features for assistance in obtaining financing, insurance services, furniture, law firm services, and the like.

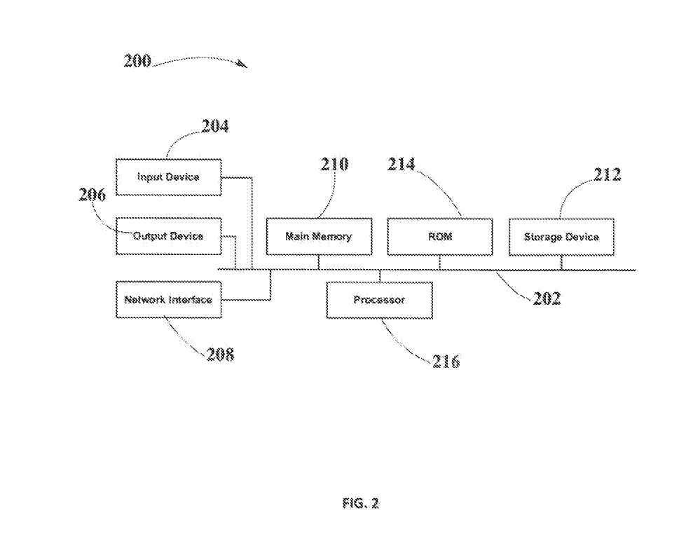

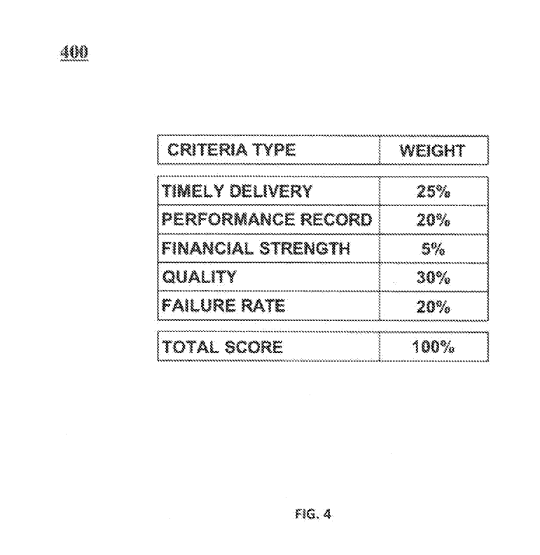

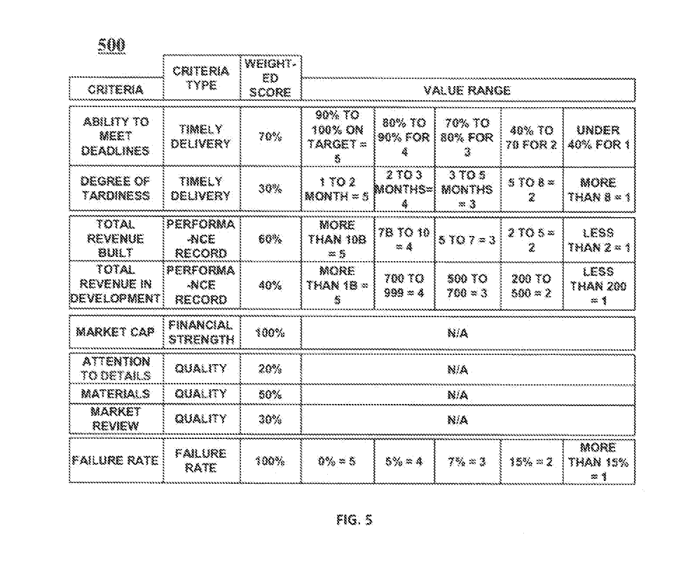

FIG. 2 is a diagram illustrating example components of a computing device 200 or server, according to an exemplary embodiment. In FIG. 2, computing device 200 includes example components of a computing device, such as, for example, a server, a laptop computer, a desktop computer, a tablet, a smartphone, and the like that may operate within system 100 of FIG. 1, that execute modules described in FIG. 3, or that execute code implementing the functions, algorithms, and/or results contained in FIGS. 4-5, according to an exemplary embodiment.

According to some aspects of this embodiment, computing device 200 includes bus 202, input device 204, output device 206, network interface 208, main memory 210, storage device 212, read only memory (ROM) 214 and processor 216. In another exemplary embodiment, computing device 200 includes additional, fewer, different, or differently arranged components than are illustrated in FIG. 2.

In one embodiment, bus 202 coordinates the interaction and communication among the components of the server. Input device 204 includes a mechanism that permits a user to input information to computing device 200, such as a keyboard, a mouse, a button, a pen, a touch screen, voice recognition and/or biometric mechanisms, etc. Output device 206 includes a mechanism that outputs information to the operator, including a display, a light emitting diode (LED), and a speaker, among other outputs.

Network interface 208 enables computer interactions with other devices and/or systems via a network connection. Network connections may refer to any suitable connection between computers such as intranets, local area networks (LAN), cloud networks, virtual private networks (VPN), wireless area networks (WAN), and the internet, among other connections.

Main memory 210, for example, includes a random access memory (RAM) or another type of dynamic storage device that may store information and instructions for execution by processor 216. ROM 214, for example, includes a ROM device or another type of static storage device that may store static information and instructions for use by processor 216. Processor 216, for example, includes a microprocessor, an application specific integrated circuit (ASIC), and a field programmable object array (FPOA), among other elements, that may interpret and execute instructions.

According to some aspects of this embodiment, server, using one or more suitable software modules, enables data fetching, biometrics processing tasks, and predictive analytics. The server performs these operations in response to processor 216 executing software instructions contained in a computer-readable medium, such as main memory 210.

The software instructions are read into main memory 210 from another computer-readable medium, such as storage device 212, or from another device via network interface 208. The software instructions contained in main memory 210 may cause processor 216 to perform processes that will be described later. Alternatively, hardwired circuitry may be used in place of or in combination with software instructions to implement processes described herein. Thus, implementations described herein are not limited to any specific combination of hardware circuitry and software.

FIG. 3 is a block diagram of an exemplary subsystem within a real estate management tool in a system for managing real estate investments, according to an embodiment. In FIG. 3, subsystem 300 includes external data sources 302, communication network 304, internal database 306, real estate management tool 308, data collection module 310, developer scoring module 312, project scoring module 314, unit scoring module 316, matching module 318, and financial module 320. It should be understood that subsystem 300 can include more components, less components, or different components depending on the desired analysis goals and that the components may be arranged differently than illustrated in subsystem 300 of FIG. 3.

In FIG. 3, real estate management tool 308, data collection module 310, developer scoring module 312, project scoring module 314, unit scoring module 316, matching module 318, and financial module 320 are operatively coupled to and in bi-directional communication with each other. Real estate management tool 308 is further operatively coupled to and in bi-directional communication with internal database 306. Furthermore, real estate management tool 308 is additionally operatively coupled to and in bi-directional communication with external data sources 302 through communication network 304.

In an example and referring to FIG. 1, real estate management tool 308, internal database 306, communication network 304 and external data sources 302 function in a substantially similar manner as real estate management tool 106, internal database 108, communication network 104 and external data sources 102 in system 100. Examples of external data sources 302 include social networks, financial institutions, marketing consultants, and the like that provide information related to the developer's performance and financial status associated with development projects and units.

In some embodiments, internal database 306 includes portfolio data associated with a plurality of developers, as well as data associated with a plurality of investors. Additionally, internal database 306 includes a plurality of criteria, value ranges, and associated weights that developer scoring module 312, project scoring module 314, and unit scoring module 316 use to calculate scores for developers, projects, and units, respectively. Exemplary embodiments of sets of criteria, ranges, and associated weights for calculating scores for developers, projects, and units will be further illustrated in FIGS. 4-9.

In some embodiments, data collection module 310 is configured to retrieve developer's portfolio data associated with a plurality of developers from external data sources 302 and store said developer's portfolio data at internal database 306. Additionally, data collection module 310 is configured to retrieve qualification data associated with a plurality of real estate investors from external data sources 302 and store said qualification data at internal database 306. In other embodiments, data collection module 310 is configured to display a user interface on a client computing device to request developer's portfolio data and real estate investor's qualification data from a user, and data collection module 310 is further configured to store the developer's portfolio data and the investor's qualification data at internal database 306.

Developer's portfolio data includes information related to the developer's performance and financial status associated with development projects and units, such as, for example, developer reliability data, project data, and unit data. Developer reliability data includes a developer's ability to meet deadlines, degree of tardiness, total revenue built, total revenue in current development, market capitalization, attention to details, materials utilized in projects, market reviews, and project failure rate, among other data. Project data includes level of supply, relative location, absolute location, key amenities present (e.g. pool, gym, spa, doorman, retail shops, and the like), walk score, average price per unit, carrying costs (e.g. maintenance and the like), and stage of development, among other data. Unit data includes the floor in which the units are located, the view the units have, average price for unit, average rental price, number of units, and the unit's availability, among other data.

In an additional embodiment, developer scoring module 312 calculates a developer score for each of the developers. In one embodiment, developer scoring module 312 assigns weights to developer's data to produce scores that range from 0% to 100%. Exemplary embodiments of criteria type, ranges, and associated weights for calculating a developer score for developers are illustrated in FIG. 4.

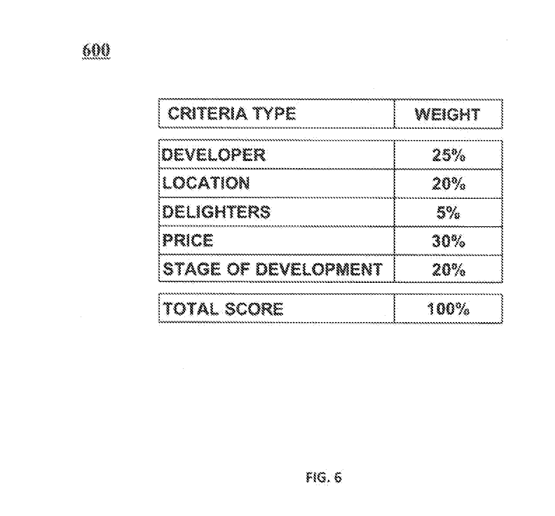

In a further embodiment, project scoring module 314 calculates a project score for each of the projects. In one embodiment, project scoring module 314 assigns weights to project data to produce scores that range from 0% to 100%. Exemplary embodiments of criteria type, ranges, and associated weights for calculating a project score for projects are illustrated in FIG. 6.

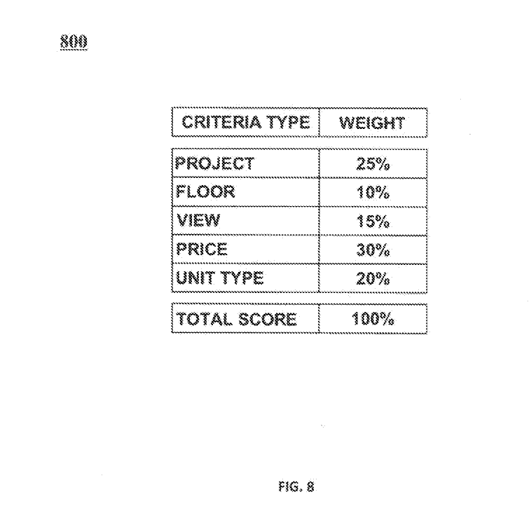

In a yet another embodiment, unit scoring module 316 calculates a unit score for each of the units. In one embodiment, unit scoring module 316 assigns weights to unit data to produce scores that range from 0% to 100%. Exemplary embodiments of criteria type, ranges, and associated weights for calculating a unit score for units are illustrated in FIG. 8.

In some embodiments, matching module 318 uses investors' data, developer scores, project scores, and unit scores to match units to investor qualification data and preferences.

In further embodiments, financial module 320 manages investment transactions between brokers and investors. In one embodiment, financial module 320 processes commission payments and redirects investors to financial entities when the investors need financial assistance and insurance services, among other functions.

FIG. 4 is an exemplary embodiment of a set of criteria, ranges, and associated weights for calculating a developer score for developers. According to the exemplary embodiment illustrated in developer criteria diagram 400, the criteria can include timely delivery, performance record, financial strength, quality, and failure rate, among other criteria. In other embodiments, developer criteria diagram 400 includes criteria types listed in developer criteria diagram 400 that are supplemented with other criteria, as well as different criteria that are implemented to calculate a developer score for associated developers. In the exemplary embodiment of developer criteria diagram 400, the weights associated with each criteria illustrated in developer criteria diagram 400 are 25%, 20%, 5%, 30%, and 20%, respectively. In other embodiments, developer criteria diagram 400 includes different weightings associated with each criteria illustrated in developer criteria diagram 400.

In this embodiment, timely delivery refers to a value assigned to the developers' ability to meet projects deadlines and the degree of tardiness of projects delivered late; performance record refers to a value assigned to the developers' total revenue developed and revenue in development; financial strength refers to a value assigned to the financial strength of the developer as compared with its peers; quality refers to a value assigned to attention to details, quality of materials and market review of the developer; while failure rate refers to a value assigned to the number of projects that have failed to deliver the expected results.

According to some embodiments, developer total score is a measure of the developers' contribution to the risk of a unit not performing at investor expectations. To calculate total score, each criteria listed in diagram 400 is scored separately on a scale from 0% to 100% and then multiplied by its corresponding weight illustrated in diagram 400, each result is then accumulated to obtain total score. In some embodiments, the value assigned to each criterion can be obtained from a subset of criteria. An exemplary embodiment of a subset of criteria that can be used to calculate a composite developer score for each criterion illustrated in diagram 400 is further detailed in FIG. 5.

FIG. 5 is an exemplary embodiment of a set of criteria, ranges, and associated weights for calculating a developer score for developers. According to the exemplary embodiment illustrated in diagram 500, criteria includes ability to meet deadlines, degree of tardiness, total revenue built, total revenue in development, market capitalization, attention to details, quality of materials, market review, and failure rate, among other criteria.

According to one embodiment, ability to meet deadlines refers to a value assigned to the developers' ability to execute projects on target. In this embodiment, a value of 5 is assigned to developers that meet their targets from 90% to 100% of their times; a value of 4 is assigned to developers that meet their targets from 80% to less than 90% of their times; a value of 3 is assigned to developers that meet their targets from 70% to less than 80% of their times; a value of 2 is assigned to developers that meet their targets from 40% to less than 70% of their times; and a value of 1 is assigned to developers that meet their targets less than 40% of their times. According to this embodiment, the score for ability to meet deadlines is obtained by dividing the value assigned to the developer by five. Further to this embodiment, ability to meet deadlines contributes with a weight of 70% to the timely delivery criteria illustrated in FIG. 4.

In another embodiment, degree of tardiness refers to a value related to how late projects were delivered by the developers. In an example, if a developer has many projects delivered late, the project that took the longest beyond the target date is used as a reference. In this example, the number of months said project was late is the value used to calculate the degree of tardiness.

In this embodiment, a value of 5 is assigned to developers having tardiness that ranges from one to less than two months, a value of 4 is assigned to developers having tardiness that ranges from two to less than three months, a value of 3 is assigned to developers having a degree of tardiness that ranges from three to less than five months, a value of 2 is assigned to developers having a degree of tardiness that ranges from five to less than eight months, and a value of 1 is assigned to developers having a degree of tardiness equal or more than eight months. According to this embodiment, the score for degree of tardiness is obtained by dividing the value assigned to the criteria by five. Further to this embodiment, ability to meet deadlines contributes with a weight of 30% to the timely delivery criteria illustrated in FIG. 4.

In a further embodiment, total revenue built refers to a value assigned to the revenue equivalent to all units already built by the developer. In this embodiment, a value of 5 is assigned to developers having more than 10 billion dollars in revenue built, a value of 4 is assigned to developers having at least 7 billion dollars but less than 10 billion dollars in revenue built, a value of 3 is assigned to developers having at least 5 billion dollars and less than 7 billion dollars in revenue built, a value of 2 is assigned to developers having at least 2 billion dollars and less than 5 billion dollars in revenue built, and a value of 1 is assigned to developers having less than 2 billion dollars in revenue built. According to this embodiment, the score for total revenue built is obtained by dividing the value assigned to the criteria by five. Further to this embodiment, total revenue built contributes with a weight of 60% to the performance record criteria illustrated in FIG. 4.

In yet another embodiment, total revenue in development refers to a revenue equivalent to all units yet to be built by the developer. In this embodiment a value of 5 is assigned to developers having more than 1 billion dollars, a value of 4 is assigned to developers having at least 700 million dollars but less than 1 billion dollars, a value of 3 is assigned to developers having at least 500 million dollars but less than 700 million dollars, a value of 2 is assigned to developers having at least 200 million dollars but less than 500 million dollars, and a value of 1 is assigned to developers having less than 200 million dollars. According to this embodiment, the score for total revenue in development is obtained by dividing the value assigned to the criteria by five. Further to this embodiment, total revenue in development contributes with a weight of 40% to the performance record criteria illustrated in FIG. 4.

In another embodiment, market cap criteria refers to market capitalization of the developer (when publicly available) as compared with their peers. In one embodiment, the value used as a reference is the total number of shares times the share's unit value. In another embodiment, the value used as a reference for the comparison is a credit score. In yet other embodiments, the value is the number of units built by the developer in a year times the units' market value.

In this embodiment, a value of 5 is assigned to developers having said criteria at least 20% above average, a value of 4 is assigned to developers having said criteria between 10% and 20% (not including 20%) above average, a value of 3 is assigned to developers having said criteria between 0% and 10% (not including 10%) above average, a value of 2 is assigned to developers having between 10% and 0% (not including 0%) below average, a value of 1 is assigned to developers having more than 10% below average. According to this embodiment, the score for market cap contributes with a weight of 100% to the financial strength criteria illustrated in FIG. 4.

In a further embodiment, attention to details refers to a criterion that measures the developer's perceived capacity for attention to details. In some embodiments, the value is obtained by reviews from investors, brokers, customers, owners, third parties, and the like. In this embodiment, a value of 5 is assigned to developers having said criteria at least 20% above average, a value of 4 is assigned to developers having said criteria between 10% and 20% (not including 20%) above average, a value of 3 is assigned to developers having said criteria between 0% and 10% (not including 10%) above average, a value of 2 is assigned to developers having between 10% and 0% (not including 0%) below average, a value of 1 is assigned to developers having more than 10% below average. According to this embodiment, the score for attention to details contributes with a weight of 20% to the quality criteria illustrated in FIG. 4

According to another embodiment, materials refers to a criterion that measures the perceived quality of materials used by the developer in projects. In some embodiments, the value is obtained by reviews from investors, brokers, customers, owners, third parties, and the like. In this embodiment, a value of 5 is assigned to developers having said criteria at least 20% above average, a value of 4 is assigned to developers having said criteria between 10% and 20% (not including 20%) above average, a value of 3 is assigned to developers having said criteria between 0% and 10% (not including 10%) above average, a value of 2 is assigned to developers having between 10% and 0% (not including 0%) below average, a value of 1 is assigned to developers having more than 10% below average. According to this embodiment, the score for materials contributes with a weight of 50% to the quality criteria illustrated in FIG. 4.

According to a further embodiment, market review refers to a criteria that measures reviews done on the developer by companies and organizations that produce developer's reviews. In this embodiment, a value of 5 is assigned to developers having said criteria at least 20% above average, a value of 4 is assigned to developers having said criteria between 10% and 20% (not including 20%) above average, a value of 3 is assigned to developers having said criteria between 0% and 10% (not including 10%) above average, a value of 2 is assigned to developers having between 10% and 0% (not including 0%) below average, a value of 1 is assigned to developers having more than 10% below average. According to this embodiment, the score for market review contributes with a weight of 30% to the quality criteria illustrated in FIG. 4.

According to yet another embodiment, failure rate refers to a value assigned to the rate of failure in proper delivery of projects by the developer vs total number projects executed by said developer. In this embodiment a value of 5 is assigned to developers having a failure rate of 0%, a value of 4 is assigned to developers having a failure rate less than or equal to 5%, a value of 3 is given to developers having a failure rate between 5% and 7% (not including 5%), a value of 2 is assigned to developers having a failure rate between 7% and 15% (not including 7%), a value of 1 is assigned to developers having a failure rate higher than 15%. According to this embodiment, the score for failure rate is obtained by dividing the value assigned to the criteria by five. Further to this embodiment, failure rate contributes with a weight of 100% to the failure rate criteria illustrated in FIG. 4.

FIG. 6 is an exemplary embodiment of a set of criteria types, ranges, and associated weights for calculating a project score for projects. According to the exemplary embodiment illustrated in project criteria diagram 600, the criteria can include developer, location, delighters, price, and stage of development, among other criteria. In this embodiment, in diagram 600, location refers to a value assigned to level of supply, absolute location, and relative location; delighters refers to a value assigned to the availability of amenities such as pool, gym, spa, retail shops, and doorman; price refers to a value assigned to average price and carrying costs, while stage of development refers to a value assigned to the stage of development of the project.

In other embodiments, project criteria diagram 600 includes criteria types listed in project criteria diagram 600 and supplemented with other criteria, as well as different criteria, that are implemented to calculate a project score for associated projects. In the exemplary embodiment of project criteria diagram 600, the associated weights for each criteria illustrated in project criteria diagram 600 are 25%, 20%, 5%, 30%, and 20%, respectively. In other embodiments, project criteria diagram 600 includes different weightings associated with each criteria illustrated in project criteria diagram 600.

In this embodiment, developer refers to a value assigned to the developer's performance. In an example, the value for developer is calculated for the developer as illustrated in FIGS. 4 and 5.

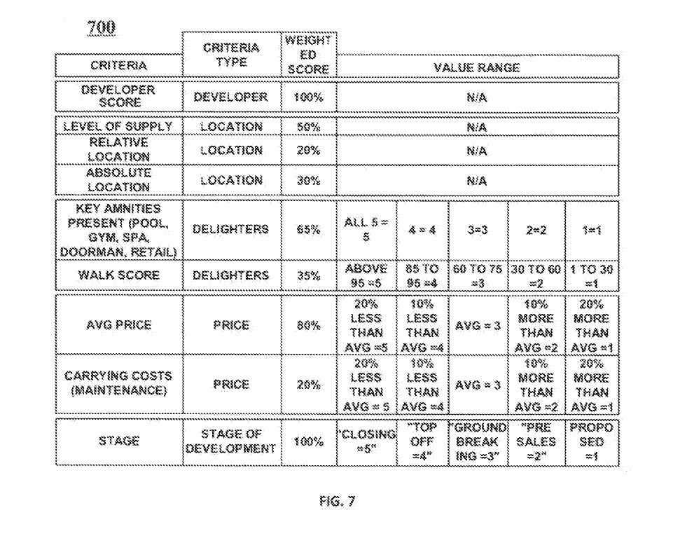

According to some embodiments, total score in diagram 600 is a measure of the projects' contribution to the risk of a unit not performing to investors' expectations. To calculate a total score, each criteria listed in diagram 600 is scored separately on a scale from 0% to a 100% and then multiplied by their corresponding weight, each result is then accumulated to obtain the total score. An exemplary embodiment of a subset of criteria that is used to calculate a composite project score for each criterion illustrated in diagram 600 is further detailed in FIG. 7.

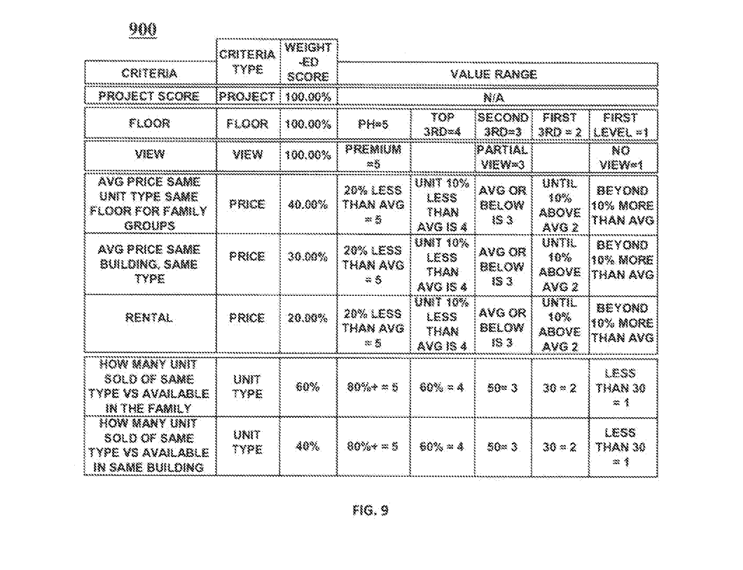

FIG. 7 is an exemplary embodiment of a set of criteria, ranges, and associated weights for calculating a project score for projects. In one embodiment, criteria in diagram 700 are used to calculate a composite project score for a project. Criteria in diagram 700 includes developer score, level of supply, relative location, absolute location, key amenities present, walk score, average price, carrying costs, and stage, among other criteria. According to one embodiment, developer score refers to a value assigned to the developer's performance. In another embodiment, developer score is the total score obtained by the developer of the project being evaluated as illustrated in FIGS. 9 and 10. According to this embodiment, the developer score contributes with a weight of 100% to the developer criteria illustrated in FIG. 6.

According to another embodiment, level of supply is a criterion that measures the number of projects of the same type in the same zone as compared to similar projects in other zones. In this embodiment, a value of 5 is assigned to developers having said criteria at least 20% below average, a value of 4 is assigned to developers having said criteria between 10% and 20% (not including 20%) below average, a value of 3 is assigned to developers having said criteria between 0% and 10% (not including 10%) below average, a value of 2 is assigned to developers having between 10% and 0% (not including 0%) above average, a value of 1 is assigned to developers having more than 10% above average. According to this embodiment, the score for level of supply contributes with a weight of 50% to the location criteria illustrated in FIG. 6.

According to yet another embodiment, relative location refers to an analysis performed by third parties which measures how well located the project is relative to other projects, such as, for example, similar projects. According to this embodiment, the score for relative location contributes with a weight of 20% to the location criteria illustrated in FIG. 6.

According to a further embodiment, absolute location refers to analyses performed by third parties which measure how well the project is located as compared to the surrounding commercial, industrial, and housing zones. According to this embodiment, the score for absolute location contributes with a weight of 30% to the location criteria illustrated in FIG. 6.

In one embodiment, key amenities present refers to a value assigned to amenities that are part of the project. According to this embodiment, key amenities present include, but are not limited to, pool, gym, spa, doorman, and retail shops that are physically located on the associated property of the project. Further to this embodiment, a value of 1 is assigned for each amenity present. In an example, if all amenities are present a value of 5 is assigned, 4 when four amenities are present, 3 when three amenities are present, 2 when two amenities are present, and 1 if at least one amenity is present. According to this embodiment, the score for key amenities present is obtained by dividing the value assigned to the criteria by five. According to some embodiments, key amenities present contributes with a weight of 65% to the delighter's criteria illustrated in FIG. 6.

In another embodiment, a walk score is one of the criteria used to calculate a project score. In some embodiments, a walk score is a value associated with the ease a user would have moving around the associated property of the project. According to this embodiment, a value of 5 is assigned to projects having a walk score of higher than 95, a value of 4 is assigned to projects having a walk score between 85 and 95 (not including 85), a value of 3 is assigned to projects having a walk score between 60 and 85 (not including 60), a value of 2 is assigned to projects having a walk score between 30 and 60 (not including 30), and a walk score of 1 is assigned to projects having a walk score less than or equal to 30. According to this embodiment, the score for walk score is obtained by dividing the value assigned to the criteria by five. According to some embodiments, walk score contributes with a weight of 35% to the delighter's criteria illustrated in FIG. 6.

In a further embodiment, average price refers to a value assigned to the average price per square foot of the entire project, as compared to other similar projects. According to this embodiment, a value of 5 is assigned to projects having average price at least 20% below average, a score of 4 is assigned to projects having average price at between 10% and 20% below average (not including 20%), a value of 3 is assigned to projects having average price between average and 10% below average (not including 10% below average), a value of 2 is assigned to projects having average price between average and 10% above average (not including average), and a value of 1 is assigned to projects having higher average prices. According to this embodiment, the score for average price is obtained by dividing the value assigned to the criteria by five. According to some embodiments, average price contributes with a weight of 80% to the price criteria illustrated in FIG. 6.

In a yet another embodiment, carrying costs refers a value assigned to costs, such as maintenance, that the investor incurs while owning the unit, as compared to maintenance costs associated with other similar projects. According to this embodiment, a value of 5 is assigned to projects having carrying costs at or under 20% below average, a score of 4 is assigned to projects having carrying costs between 10% and 20% (not including 20%) below average, a value of 3 is assigned to projects having carrying costs between average and 10% below average (not including 10% below average), a value of 2 is assigned to projects having carrying costs between average and 10% more than average (not including average), and a value of 1 is assigned to projects having higher carrying costs. According to this embodiment, the score for carrying costs is obtained by dividing the value assigned to the criteria by five. According to some embodiments, carrying costs contributes with a weight of 20% to the price criteria illustrated in FIG. 6.

In some embodiments, stage refers to a value assigned to the stage of development associated with the project. According to this embodiment, a value of 5 is assigned to projects in the closing stage, a value of 4 is assigned to projects in the top off stage, a value of 3 is assigned to projects in the ground breaking stage, a value of 2 is assigned to projects in the pre-sales stage, and a value of 1 is assigned to projects in the proposed stage. According to this embodiment, the score for stage is obtained by dividing the value assigned to the criteria by five. According to some embodiments, stage contributes with a weight of 100% to the stage of development criteria illustrated in FIG. 6.

FIG. 8 is an exemplary embodiment of a set of criteria types, ranges, and associated weights for calculating a unit score for units. According to the exemplary embodiment illustrated in unit criteria 800, the criteria include property, floor, view, price, and unit type, among other criteria. In other embodiments, unit criteria diagram 800 includes criteria types listed in unit criteria diagram 800 and supplemented with other criteria, as well as different criteria, that are implemented to calculate a unit score for associated projects. In the exemplary embodiment of unit criteria diagram 800, the associated weights for each criteria illustrated in criteria unit diagram 800 are 25%, 10%, 15%, 30%, and 20%, respectively. In other embodiments, unit criteria diagram 800 includes different weightings associated with each criteria illustrated in unit criteria diagram 800.

In this embodiment, a project criterion is a measure of the project's potential attractiveness for investors. In another embodiment, project refers to the total score obtained by the project as illustrated in FIGS. 6 and 7. Further to this embodiment, floor refers to a value assigned to the floor in which the unit is located, view refers to a value assigned to the type of view the unit has, price refers to a value assigned to the price of the unit, unit type refers to a value assigned to the likelihood that the unit will sell.

According to some embodiments, total score in diagram 800 is a measure of the risk of a unit not performing to investors' expectations. To calculate total score, each criteria listed in diagram 800 is scored separately on a scale from 0% to a 100% and then multiplied by its corresponding weight illustrated in diagram 800, each result is then accumulated to obtain a total score. An exemplary embodiment of a subset of criteria that is used to calculate a composite unit score for each criterion illustrated in diagram 800 is further detailed in FIG. 9.

FIG. 9 is an exemplary embodiment of a set of criteria, ranges, and associated weights for calculating a unit score for units. In one embodiment, criteria in diagram 900 includes project score, floor, view, average price same unit type same floor for family groups, average price same building, same type, rental, how many units sold of same type vs available in the same family, and how many units sold of same type vs available in the same building, among other criteria.

According to one embodiment, project score is a measure of the project's contribution to the risk of the unit not performing to investors' expectations. In another embodiment, project score refers to the total score obtained by the project of the unit being evaluated as illustrated in FIGS. 6 and 7. According to this embodiment, project score contributes with a weight of 100% to the project criteria illustrated in FIG. 8.

According to another embodiment, floor refers to a value assigned to the floor in which the unit is located. In this embodiment, a value of 5 is assigned for units that are located in the penthouse, a value of 4 is assigned to units on the top third floors, a value of 3 is assigned to units on the second third floors, a value of 2 is assigned to units on the first third floors, and a value of 1 is assigned to units on the first floor. According to this embodiment, the score for floor is obtained by dividing the value assigned to the criteria by five. According to some embodiments, floor contributes with a weight of 100% to the floor criteria illustrated in FIG. 8.

According to yet another embodiment, view refers to a value assigned to the view the unit has. In this embodiment, a value of 5 is assigned for units with a premium view, a value of 3 is assigned to units with a partial view, and a value of 1 is assigned to having no view. According to this embodiment, the score for view is obtained by dividing the value assigned to the criteria by five. According to some embodiments, view contributes with a weight of 100% to the view criteria illustrated in FIG. 8.

In a further embodiment, average price same unit type same floor for family groups refers to a valuation that is the average price per square foot for units of the same type in the same floor for the same family group. According to this embodiment, a value of 5 is assigned to units having this valuation at or under 20% below average, a score of 4 is assigned to units having this valuation between 10% and 20% below average (not including 20%), a value of 3 is assigned to units having this valuation between average and 10% below average (not including 10%), a value of 2 is assigned to units having this valuation between average and 10% above average (not including average), a value of 1 is assigned to units having a higher valuation. According to this embodiment, the score for average price same unit type same floor for family groups is obtained by dividing the value assigned to the criteria by five. According to some embodiments, this criterion contributes with a weight of 40% to the price criteria illustrated in FIG. 8.

In yet another embodiment, average price same building same type refers to a valuation that is the average price per square foot for units of the same type in the building. According to this embodiment, a value of 5 is assigned to units having this valuation at or under 20% below average, a score of 4 is assigned to units having this valuation between 10% and 20% below average (not including 20%), a value of 3 is assigned to units having this valuation between average and 10% below average (not including 10%), a value of 2 is assigned to units having this valuation between average and 10% above average (not including average), a value of 1 is assigned to units having a higher valuation. According to this embodiment, the score for average price same building same type is obtained by dividing the value assigned to the criteria by five. According to some embodiments, this criterion contributes with a weight of 30% to the price criteria illustrated in FIG. 8.

According to another embodiment, rental refers to a ratio that is the rent value (after discounting for property taxes and maintenance fees) divided by the value of the unit. According to this embodiment, a value of 5 is assigned to units having this ratio at or higher than 20% above average, a score of 4 is assigned to units having this ratio between 10% and 20% above average (not including 20%), a value of 3 is assigned to units having this ratio between average and 10% above average (not including 10%), a value of 2 is assigned to units having this ratio between average and 10% below average (not including average), a value of 1 is assigned to units having a lower ratio. According to this embodiment, the score for this criterion is obtained by dividing the value assigned to the criteria by five. According to some embodiments, this criterion contributes with a weight of 20% to the price criteria illustrated in FIG. 8.

In further embodiments, how many units sold of same type vs available in the family is a ratio calculated by dividing the number of units sold by the numbers of units of the same family still available. According to this embodiment, a value of 5 is assigned to units having this ratio at or higher than 80%, a score of 4 is assigned to units having this ratio between 60% and 80% (not including 80%), a value of 3 is assigned to units having this ratio between 50% and 60% (not including 60%), a value of 2 is assigned to units having this ratio between 30% and 50% (not including 50%), and a value of 1 is assigned to units having a lower ratio. According to this embodiment, the score for this criterion is obtained by dividing the value assigned to the criteria by five. According to some embodiments, this criterion contributes with a weight of 20% to the unit type criteria illustrated in FIG. 8.

In some embodiments, how many units sold of same type vs. available in the same building is a ratio calculated by dividing the number of units sold by the number of units of the same type still available in the same building. According to this embodiment, a value of 5 is assigned to units having this ratio at or higher than 80%, a score of 4 is assigned to units having this ratio between 60% and 80% (not including 80%), a value of 3 is assigned to units having this ratio between 50% and 60% (not including 60%), a value of 2 is assigned to units having this ratio between 30% and 50% (not including 50%), and a value of 1 is assigned to units having a lower ratio. According to this embodiment, the score for this criterion is obtained by dividing the value assigned to the criteria by five. According to some embodiments, this criterion contributes with a weight of 20% to the unit type criteria illustrated in FIG. 9.

FIG. 10 is flowchart of a method for assigning scores to developers, projects and units, according to an embodiment. In FIG. 10, method 1000 includes a plurality of steps that may be performed by one or more computing devices, such as computing device 200 of FIG. 2, implementing/running one or more software modules/processes of the exemplary operating environments of FIGS. 1 and 3. The steps of this exemplary method can be embodied in a computer readable medium containing computer readable code such that the steps are implemented when the computer readable code is executed by a computing device. In some implementations, certain steps of the method can be combined, performed simultaneously, or in a different order, without deviating from the objective of the method.

At step 1002, a data collection module collects developers' portfolio data associated with a plurality of developers from external sources and stores said developers' portfolio data at an internal database. In other embodiments, data collection module collects developer's portfolio data from a user interacting with a user interface displayed in a client computing device.

In one embodiment, information about developers, collected at step 1002, includes developer's ability to meet deadlines rated from 0% to 100%, degree of tardiness measured in months, total revenue built measured in US dollars, total revenue in development measured in US dollars, market capitalization rated from 0% to 100%, attention to details rated from 0% to 100%, quality of materials utilized in projects rated from 0% to 100%, market reviews rated from 0% to 100%, and projects failure rate rated from 0% to a 100%, among other information. Additional data collected by the data collection module includes developer's name, address, email, phone, contact name and logo, among other data.

In a further embodiment, information about projects, collected at step 1002, includes a level of supply rated from 0% to 100%, relative location rated from 0% to 100%, absolute location rated from 0% to 100%, key amenities present (e.g. pool, gym, spa, doorman, and retail shops), walk score rated from 0% to 100%, average price per housing unit, average carrying costs, and stage of development (e.g. closing, top off, ground breaking, pre-sales, or proposed), among other information. Additional data collected by the data collection module includes project name, location, address, number of stories in the building, project highlights, number of towers, parking spaces, project features, name of the architect, and name of the interior designer, among other data.

In yet another embodiment information about units, collected at step 1002, includes the floor in which the unit is located as compared to the number of floors in the building, the view the units have (e.g. premium, partial, or no view), average price for the same units in the same floor for family groups, average price for units of the same type in the same building, rental price, number of units of the same type sold versus available in the same family, number of units sold versus available in the same building, among other information.

At step 1004, the data collection module stores developer's portfolio data. The developers' portfolio data stored at step 1004 by the data collection module includes the data collected at step 1002 and additional data including company name, address, email, phone, contact name and logo, among other data. Additional data collected by the data collection module includes number of bedrooms, name of the tower the unit is located in, number of baths, number of balconies, size of the balconies, size of the unit, size of the residence within the unit, and total price, among other data.

At step 1006, a developer scoring module assigns scores to developers, projects and units. In one embodiment, the developer scoring module assign weights to the data collected by the data collection module to produce an overall score for developers, projects and units. In this embodiment, the developer scoring module retrieves from an internal database a matrix of weights to assign to a predetermined set of criteria. In some embodiments, the set of criteria includes subsets of criteria to which weights are assigned, resulting in a series of parent-child sets of criteria. In these embodiments, the developer scoring module fits the data into ranges and then assigns weights to the criteria as it fits in the ranges.

In another embodiment, the developer scoring module assigns weights to subsets of criteria and aggregates said scores to their parent set of criteria in order to produce an overall score for each developer, project, and unit. In some embodiments, the resulting score ranges from 0 to 100, in another embodiments the resulting score ranges from 1 to 5, in yet another embodiment, the resulting score is given alphabetical tags.

The processes described herein may be executed through one or more computing devices of the system described in FIG. 2, allowing the system for managing real estate investments a more efficient and faster processing of large data sets. The real estate management tool allows an investor to identify real estate investments, while in the pre-construction stage, that are less risky using an automated and faster method than possible with human-intervention data-driven analysis. In this way, efficiencies are created by providing the investors with ways to reduce risk by providing indicators that are independent of both investors and developers.

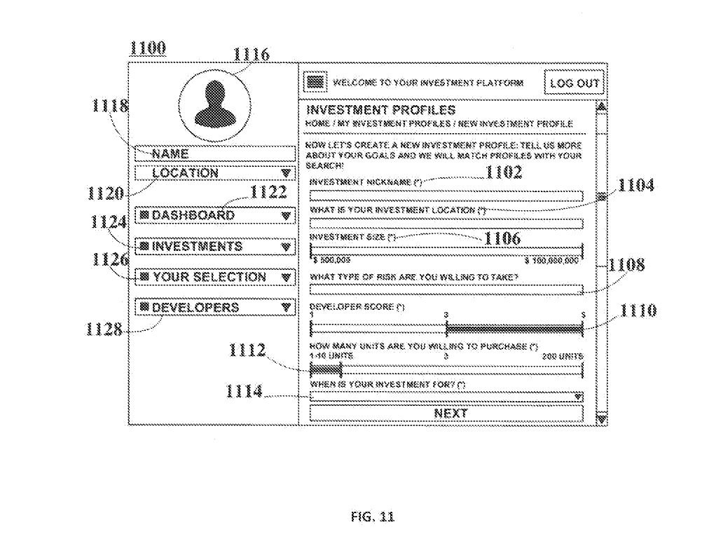

FIG. 11 is an exemplary illustration of a user interface in the real estate management tool that allows investors to initiate real estate investment research. In one or more embodiments, the user interface for the real estate management tool creates an investment profile for the investor that is stored in an internal database. In FIG. 11, user interface 1100 includes a first set of questions that allows the real estate management tool to generate an initial search criterion for creating an investment profile. In one or more embodiments, the first set of questions includes investment nickname field 1102, investment location field 1104, investment size slider bar 1106, type of risk field 1108, developer score slider bar 1110, number of units to purchase slider bar 1112, and time for investment field 1114. User interface 1100 further includes a side menu, displayed on the left hand side of the screen, which includes profile picture 1116, name 1118, location of the investor 1120, dashboard 1122, investments 1124, your selection 1126, and developers 1128. It should be understood that user interface 1100 can include less settings, more settings, or different settings depending on the desired goals.

In an exemplary embodiment, user interface 1100 displays to the investor a list of settings that the investor can use to configure the real estate management tool to perform a customized investment research on real estate preconstructions. In this embodiment, the investor chooses a nickname in the real estate management tool, and selects a location in which he or she desires to invest (e.g., City, State, and Country). Further to this embodiment, the investor can also select the investment size (e.g., the investment size goes from $500,000 to $100,000), select the type of risk he or she is willing to take (e.g., low, medium, high, or very high), select the developer score (e.g., 1-5), select the number of units he/she wishes to purchase, and when he or she wants to invest (e.g., immediately).

In another exemplary embodiment, user interface 1100 displays a second set of questions (not shown in FIG. 11) to further narrow down the investment research. In this exemplary embodiment, the questions are related to providing details about the project in which the investor wants to invest. For example, the questions include data related to the design/style of the project (e.g., Co-op, Condo, Fee simple, Leasehold, or any), branded project, project size, type of finishes (e.g., decorator ready, unfinished, finished, or furnished), and type of amenities.

In yet another exemplary embodiment, user interface 1100 displays a third set of questions (not shown in FIG. 11) to further narrow down the investment research. In this exemplary embodiment, the questions can be used to provide details about the units of the project in which the investor wants to invest. For example, the questions include data related to unit specifics, such as size in square feet (e.g., range from 400 to 50000), number of bedrooms (e.g., 0 to 15), number of bathrooms (e.g., 1-10), specific view (e.g., Water, Partial Water, City, Premium, No view, or Does not matter), specific height (e.g., lower units, lower half, or upper half), or specific unit (e.g., Lanai, Penthouse, or Liner), among others. In a further exemplary embodiment, user interface 1100 displays a fourth set of questions (not shown in FIG. 11) to provide the investor with features for assistance in financing, insurance services, furniture, law firms, and the like.

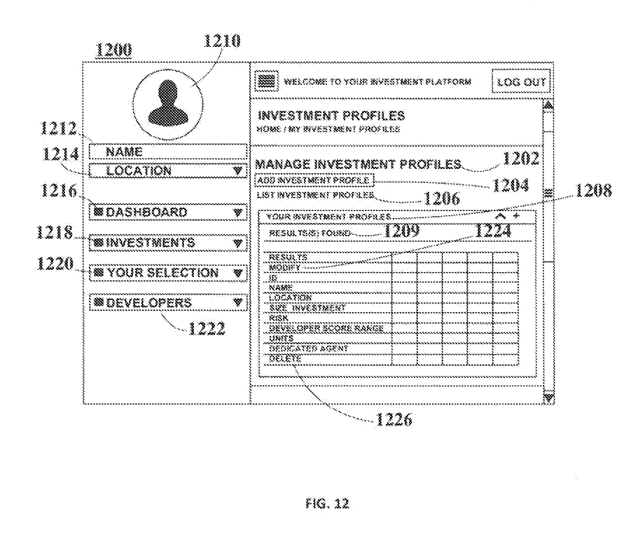

FIG. 12 is an exemplary illustration of a user interface in the real estate management tool that allows investors to manage their investment profiles. In FIG. 12, user interface 1200 includes manage investment profiles 1202, add investment profile 1204, list investment profiles 1206, recent investment research 1208, and results found 1209. User interface 1200 further includes a side menu, displayed on the left hand side of the screen, which includes profile picture 1210, name 1212, location of the investor 1214, dashboard 1216, investments 1218, your selection 1220, and developers 1222. It should be understood that user interface 1200 can include less settings, more settings, or different settings depending on the desired goals.

In an exemplary embodiment, user interface 1200 displays to the investor a dashboard that allows the investors to easily manage and track all of their investment research results. In one or more embodiments, user interface 1200 displays the most recent investment research results found including an ID of the investment research, name, location, size investment, risk, developer score range, units available, and a dedicated agent. In these embodiments, the investor is given the option to modify the investment research 1224 and to delete 1226 the results.

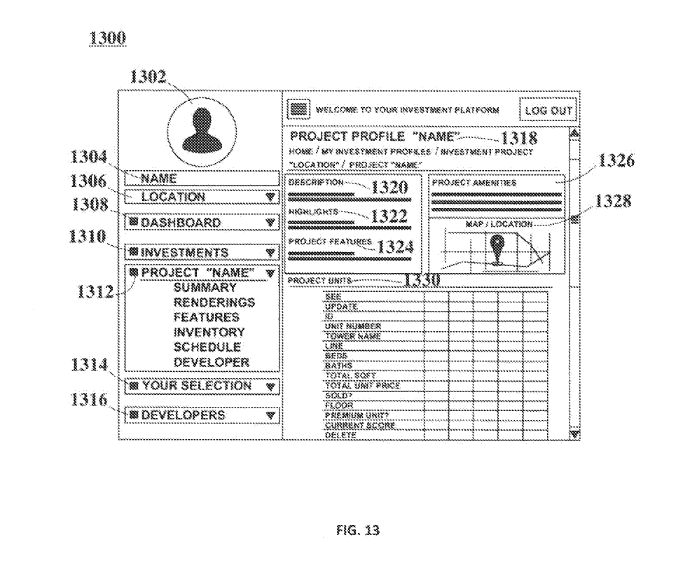

FIG. 13 is an exemplary illustration of a user interface in the real estate management tool that allows investors to look at project profiles of interest. In FIG. 13, user interface 1300 includes a side menu, displayed on the left hand side of the screen, which includes profile picture 1302, name 1304, location of the investor 1306, dashboard 1308, investments 1310, project 1312, your selection 1314, and developers 1316. In one or more embodiments, user interface 1300 further includes detailed information about the project profile such as, for example, name of the project 1318, description of the project 1320, highlights 1322, project features 1324, project amenities 1326, and location on map 1328. In these embodiments, user interface 1300 also displays detailed information about project units 1330 such as, for example, ID, unit number, tower name, line, beds, baths, total square feet, total unit price, if the unit has been sold or not, floor, if the unit is a premium unit, and the current unit score. Further to these embodiments, user interface 1300 provides the investor with options to update, see, and delete the unit information. It should be understood that user interface 1300 can include less settings, more settings, or different settings depending on the desired goals.

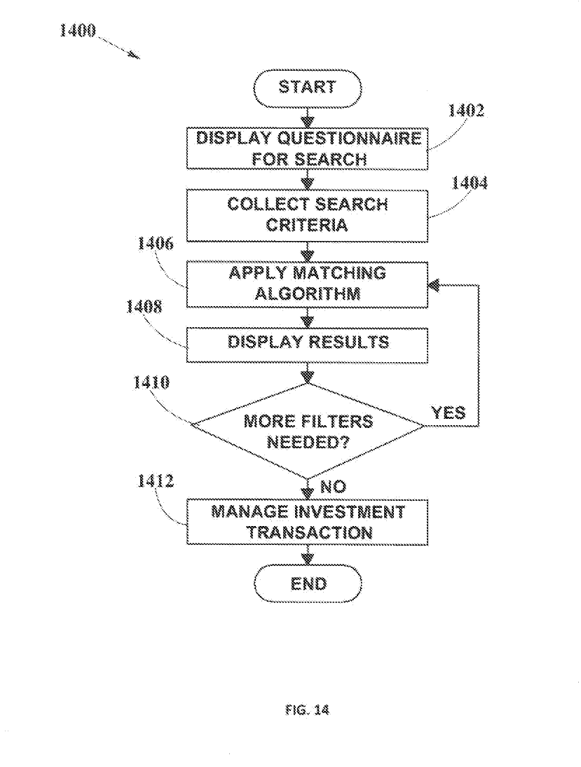

FIG. 14 is flowchart of a method for performing a search of units in the real estate management tool. In FIG. 14, method 1400 includes a plurality of steps that may be performed by one or more computing devices, such as computing device 200 of FIG. 2, implementing/running one or more software modules/processes of the exemplary operating environments of FIGS. 1 and 3. The steps of this exemplary method can be embodied in a computer readable medium containing computer readable code such that the steps are implemented when the computer readable code is executed by a computing device. In some implementations, certain steps of the method can be combined, performed simultaneously, or in a different order, without deviating from the objective of the method.

In one or more embodiments, method 1400 begins when a data collection module, which resides in the real estate management tool, generates a user interface that displays a questionnaire for investors used for searching units (step 1402). In these embodiments, data collection module displays a questionnaire, as the one described on FIG. 11, that includes qualification data of the investors, details about projects, and unit specifics. Examples of qualification data include location, neighborhood, type of location premium, investment size, carrying cost budget, type of risk, developer score requirement, number of units to purchase, location of unit within the building, and type of mix. Further to these embodiments, examples of details on the project includes design/style of the project, type of ownership, branded project, project size, type of finishes, and type of amenities. In these embodiments, the qualification data also includes unit specifics such as, for example, size of the unit in square feet, number of bedrooms, number of bathrooms, specific views, specific heights, and special units. Further to these embodiments, the qualification data also provides referral questions that include if the investor requires financing, range of financing as a percentage, assistance with financing, assistance with finishes, assistance with insurance services, assistance with furniture, assistance with a law firm, and the like. Method 1400 then advances to step 1404.

At step 1404, the data collection module collects the search criteria previously provided by the investors in step 1402 and creates an investment profile for investors that is stored at internal database. Method 1400 then advances to step 1406. At step 1406, a matching module, which resides in the real estate management tool, executes an algorithm that retrieves investors' investment profile, developer scores, project scores, and unit scores from internal database so as to match units to investors' investment profile and preferences. Method 1400 then advances to step 1408.

At step 1408, the data collection module sends results to the investor's user interface and displays an initial set of results showing the best units that the investor should invest according to his/her desires. In one or more embodiments, the investor has the option to sort the search results by developers or by projects. When the investor selects the option to sort the search results, the data collection module can generate a sorted list of the best units based on the inventor's preferences, and send the sorted list to the investor's user interface and the investor's user interface can display the sorted list. Method 1400 then advances to a decision step 1410.

At decision step 1410, the data collection module verifies if more filters are needed to further narrow the investor's search. If more filters are needed, the collection module shows more options through the user interface where the investor may select to narrow down his/her search. Method 1400 then returns to step 1406. If more filters are not needed, method 1400 advances to step 1412.

At step 1412, the financial module, which resides in the real estate management tool, generates a list of options that facilitates the management of the investment transactions for the investors, brokers, and developers. The real estate management tool displays those options through the investor's user interface. In one or more embodiments, the financial module processes commission payments, redirects the investor (e.g., automatically redirects a device of the inventor) to financial entities (e.g., to webpages of the financial entities) when the investor needs financial assistance, and provides insurance services, among other functions. Method 1400 ends.

In some embodiments, a plurality of processes that are part of the method for performing a search of units in the real estate management tool are performed by one or more computing devices such as computing device 200. The methods are implemented with components of the exemplary operating environments of FIGS. 1-3 and FIGS. 11-13. The steps of this exemplary method can be embodied in a computer readable medium containing computer readable code such that the steps are implemented when the computer readable code is executed by a computing device. While the blocks in the disclosed processes are shown in a particular order, the actual order may differ. In some embodiments, some steps may be performed in parallel.

The foregoing method descriptions and the process flow diagrams are provided merely as illustrative examples and are not intended to require or imply that the steps of the various embodiments must be performed in the order presented. As will be appreciated by one of skill in the art, the steps in the foregoing embodiments may be performed in any order. Words such as “then,” “next,” etc. are not intended to limit the order of the steps; these words are simply used to guide the reader through the description of the methods. Although process flow diagrams may describe the operations as a sequential process, many of the operations may be performed in parallel or concurrently. In addition, the order of the operations may be re-arranged. A process may correspond to a method, a function, a procedure, a subroutine, a subprogram, etc. When a process corresponds to a function, its termination may correspond to a return of the function to the calling function or the main function.

The various illustrative logical blocks, modules, circuits, and algorithm steps described in connection with the embodiments disclosed here may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

Embodiments implemented in computer software may be implemented in software, firmware, middleware, microcode, hardware description languages, or any combination thereof. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting. Thus, the operation and behavior of the systems and methods were described without reference to specific software code and software and control hardware can be designed to implement the systems and methods based on the description herein.

When implemented in software, the functions may be stored as one or more instructions or code on a non-transitory computer-readable or processor-readable storage medium. The steps of a method or algorithm disclosed herein may be embodied in a processor-executable software module which may reside on a computer-readable or processor-readable storage medium. A non-transitory computer-readable or processor-readable media includes both computer storage media and tangible storage media that facilitate transfer of a computer program from one place to another. A non-transitory processor-readable storage media may be any available media that may be accessed by a computer. By way of example, and not limitation, such non-transitory processor-readable media may comprise RAM, ROM, EEPROM, CD-ROM or other optical disk storage, magnetic disk storage or other magnetic storage devices, or any other tangible storage medium that may be used to store desired program code in the form of instructions or data structures and that may be accessed by a computer or processor. Disk and disc, as used here, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and/or instructions on a non-transitory processor-readable medium and/or computer-readable medium, which may be incorporated into a computer program product.

When implemented in hardware, the functionality may be implemented within circuitry of a wireless signal processing circuit that may be suitable for use in a wireless receiver or mobile device. Such a wireless signal processing circuit may include circuits for accomplishing the signal measuring and calculating steps described in the various embodiments.

The hardware used to implement the various illustrative logic, logical blocks, modules, and circuits described in connection with the aspects disclosed herein may be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

Any reference to claim elements in the singular, for example, using the articles “a,” “an” or “the,” is not to be construed as limiting the element to the singular.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims, the principles, and novel features disclosed herein.

What is claimed is:

1. A system for communicating scoring information to a remote computing device, the system comprising:
a central server comprising:
a memory that stores instructions and a destination address for the remote computing device;
a transmitter; and
a processor, operably connected to the memory and the transmitter, that executes the instructions to perform operations comprising:
obtaining, from external data sources, information comprising developer information, project information, and unit information corresponding to one or more real estate developers;
determining developer scores for the one or more real estate developers based on the developer information;
determining project scores for one or more projects of the one or more real estate developers based on the project information;
determining unit scores for one or more units of the one or more projects based on the unit information;
receiving a request from the remote computing device comprising the destination address of the remote computing device;
generating a user interface application;
transmitting, using the transmitter, the user interface application to the remote computing device based on the destination address, wherein the transmission activates the user interface application to cause the user interface application to display on the remote computing device and to enable connection to the central server to access more information;
receiving qualification data from the remote computing device via the user interface application;
receiving search criteria from the remote computing device via the user interface application;
determining a list of one or more matched units based on the developer scores, the project scores, the unit scores, the qualification data, and the search criteria; and
transmitting, using the transmitter, the list of one or more matched units to the remote computing device via the user interface application, whereby the list of one or more matched units is displayed on the remote computing device by the user interface application.

2. The system of claim 1, the operations further comprising:
receiving a request from the remote computing device to sort the list of one or more matched units by developers or by projects;
generating a sorted list of the list of one or more matched units based on the request; and
transmitting the sorted list to the remote computing device via the user interface application.

3. The system of claim 1, the operations further comprising:
transmitting filter options to the remote computing device via the user interface application;
receiving filter selections from the remote computing device;
determining a second list of one or more matched units based on the developer scores, the project scores, the unit scores, the qualification data, the search criteria, and the filter selections; and
transmitting, using the transmitter, the second list of one or more matched units to the remote computing device via the user interface application, whereby the second list of one or more matched units is displayed on the remote computing device by the user interface application.

4. The system of claim 1, the operations further comprising:
transmitting financial management options to the remote computing device via the user interface application, whereby the financial management options are displayed on the remote computing device by the user interface application.

5. The system of claim 4, wherein one of the financial management options is to process commission payments

6. The system of claim 4, wherein one of the financial management options is to redirect the remote computing device to a webpage of a financial entity.

7. The system of claim 1, wherein the developer information comprises timely delivery information, performance record information, financial strength information, quality information, failure rate information, or a combination thereof.

8. The system of claim 1, wherein the project information comprises developer information, location information, delighters information, price information, state of development information, or a combination thereof.

9. The system of claim 1, wherein the unit information comprises project information, floor information, view information, price information, unit type information, or a combination thereof.

10. The system of claim 1, wherein determining the developer scores, the project scores, and the unit scores comprises assigning criteria weights to the developer information, the project information, and the unit information, respectively.

11. A method for communicating scoring information to a remote computing device, the method comprising:
obtaining, from external data sources, information comprising developer information, project information, and unit information corresponding to one or more real estate developers;
determining developer scores for the one or more real estate developers based on the developer information;
determining project scores for one or more projects of the one or more real estate developers based on the project information;
determining unit scores for one or more units of the one or more projects based on the unit information;
receiving a request from the remote computing device comprising a destination address of the remote computing device;
generating a user interface application;
transmitting, using a transmitter, the user interface application to the remote computing device based on the destination address, wherein the transmission activates the user interface application to cause the user interface application to display on the remote computing device and to enable connection to the central server to access more information;
receiving qualification data from the remote computing device via the user interface application;
receiving search criteria from the remote computing device via the user interface application;
determining a list of one or more matched units based on the developer scores, the project scores, the unit scores, the qualification data, and the search criteria; and
transmitting, using the transmitter, the list of one or more matched units to the remote computing device via the user interface application, whereby the list of one or more matched units is displayed on the remote computing device by the user interface application.

12. The method of claim 11, further comprising:
receiving a request from the remote computing device to sort the list of one or more matched units by developers or by projects;
generating a sorted list of the list of one or more matched units based on the request; and
transmitting the sorted list to the remote computing device via the user interface application.

13. The method of claim 11, further comprising:
transmitting filter options to the remote computing device via the user interface application;
receiving filter selections from the remote computing device;
determining a second list of one or more matched units based on the developer scores, the project scores, the unit scores, the qualification data, the search criteria, and the filter selections; and
transmitting, using the transmitter, the second list of one or more matched units to the remote computing device via the user interface application, whereby the second list of one or more matched units is displayed on the remote computing device by the user interface application.

14. The method of claim 11, further comprising:
transmitting financial management options to the remote computing device via the user interface application, whereby the financial management options are displayed on the remote computing device by the user interface application.

15. The method of claim 14, wherein one of the financial management options is to process commission payments

16. The method of claim 14, wherein one of the financial management options is to redirect the remote computing device to a webpage of a financial entity.

17. The method of claim 11, wherein the developer information comprises timely delivery information, performance record information, financial strength information, quality information, failure rate information, or a combination thereof.

18. The method of claim 11, wherein the project information comprises developer information, location information, delighters information, price information, state of development information, or a combination thereof.

19. The method of claim 11, wherein the unit information comprises project information, floor information, view information, price information, unit type information, or a combination thereof.

20. A non-transitory, computer-readable medium storing instructions that, when executed by one or more processors of a computing system, cause the computing system to perform operations for communicating scoring information to a remote computing device, the operations comprising:
obtaining, from external data sources, information comprising developer information, project information, and unit information corresponding to one or more real estate developers;
determining developer scores for the one or more real estate developers based on the developer information;
determining project scores for one or more projects of the one or more real estate developers based on the project information;
determining unit scores for one or more units of the one or more projects based on the unit information;
receiving a request from the remote computing device comprising a destination address of the remote computing device;
generating a user interface application;
transmitting, using a transmitter, the user interface application to the remote computing device based on the destination address, wherein the transmission activates the user interface application to cause the user interface application to display on the remote computing device and to enable connection to the central server to access more information;
receiving qualification data from the remote computing device via the user interface application;
receiving search criteria from the remote computing device via the user interface application;
determining a list of one or more matched units based on the developer scores, the project scores, the unit scores, the qualification data, and the search criteria; and
transmitting, using the transmitter, the list of one or more matched units to the remote computing device via the user interface application, whereby the list of one or more matched units is displayed on the remote computing device by the user interface application.
